(19) United States
(12) Patent Application Publication
(10) Pub. No.: US 2021/0286452 A1
(43) Pub. Date: Sep. 16, 2021

(54) STYLUS AND TOUCH DEVICE

(71) Applicant: LUXSHARE PRECISION INDUSTRY CO., LTD., Bao'an District (CN)

(72) Inventors: Rongqin LAN, Shenzhen (CN); Min FAN, Shenzhen (CN); Yun FENG, Shenzhen (CN)

(73) Assignee: LUXSHARE PRECISION INDUSTRY CO., LTD., Bao'an District (CN)

(21) Appl. No.: 17/015,847

(22) Filed: Sep. 9, 2020

(30) Foreign Application Priority Data
Mar. 10, 2020 (CN) 202010162155.0

(51) Int. Cl. G06F 3/0354; H04R 1/10

(52) U.S. Cl. CPC G06F 3/03545; H04R 2420/07; H04R 1/1025

(57) ABSTRACT

Disclosed are a stylus and a touch device. The stylus includes a barrel structure, a first body assembly, a second body assembly and a stylus tip. A functional compartment, a charging compartment and a battery compartment are sequentially arranged in the barrel structure, and a charging electrode is disposed in the charging compartment. The first body assembly is located in the functional compartment and electrically connected to the charging electrode. The second body assembly is located in the battery compartment. The second body assembly is electrically connected to the charging electrode and the first body assembly separately, the second body assembly includes a rechargeable battery, and the rechargeable battery is configured to provide electrical energy to the charging electrode through the first body assembly and the second body assembly so as to enable the charging electrode to charge a wireless earphone accommodated in the charging compartment.

### CROSS-REFERENCE TO RELATED APPLICATION

This application claims priority to a Chinese patent application No. 202010162155.0 filed on Mar. 10, 2020, disclosure of which is incorporated herein by reference in its entirety.

### TECHNICAL FIELD

The present disclosure relates to a technical field of touch electronics and, in particular, to a stylus and a touch device.

### BACKGROUND

To facilitate touch operation, touch mobile terminals such as mobile phones, televisions or tablet computers are usually each equipped with a capacitive pen.

In the related art, the head of a barrel of the capacitive pen is provided with a stylus tip for touching on a touch mobile terminal, and the middle or tail of the barrel is usually provided with one or more function buttons for controlling one or more functions of the stylus tip, such as turning on the writing function or the eraser function of the stylus tip. However, the barrel of the capacitive pen has fewer functions, resulting in a lower utilization rate of the capacitive pen.

### SUMMARY

The present disclosure provides a stylus and a touch device with rich functions, thereby improving the utilization rate of the stylus and thus improving the utilization value of the stylus.

As conceived above, the present disclosure has the technical solutions below.

The present disclosure provides a stylus, which includes a barrel structure, a first body assembly, a second body assembly and a stylus tip. A functional compartment, a charging compartment and a battery compartment are sequentially arranged in the barrel structure, and a charging electrode is disposed in the charging compartment. The first body assembly is located in the functional compartment and electrically connected to the charging electrode. The second body assembly is located in the battery compartment and is electrically connected to the charging electrode and the first body assembly respectively. The second body assembly includes a rechargeable battery, and the rechargeable battery is configured to provide electrical energy to the charging electrode through the first body assembly and the second body assembly so as to enable the charging electrode to charge a wireless earphone accommodated in the charging compartment. The stylus tip is located at one end of the barrel structure.

In an embodiment, the barrel structure includes a first sleeve and a second sleeve that are detachably connected, the functional compartment is located in the first sleeve, the battery compartment is located in the second sleeve, one end of the first sleeve has a first recess, one end of the second sleeve has a second recess, and the first recess and the second recess are capable of engaging with each other to form the charging compartment.

In an embodiment, the second body assembly is electrically connected to the first body assembly through a first power terminal and a second power terminal, the first power terminal is fixed to the first sleeve and electrically connected to the first body assembly, the second power terminal is fixed to the second sleeve and electrically connected to the second body assembly, and when the first sleeve is connected to the second sleeve, the first power terminal is enabled to be in contact with and electrically connected to the second power terminal.

In an embodiment, the stylus includes two first power terminals and two second power terminals, one end of each of the first power terminals is a spring, one end of each of the two second power terminals is a ring fixed to the second sleeve, and when the first sleeve is connected to the second sleeve, the spring of the each of the two first power terminals is enabled to be in contact with and electrically connected to the ring of the each of the two second power terminals on a one-to-one basis.

In an embodiment, the functional compartment and the first recess are separated by a first partition, the charging electrode includes a third power terminal and a first connector, the barrel structure has a first through hole and a second through hole penetrating the functional compartment and the charging compartment, the third power terminal is electrically connected to the first body assembly after passing through the first through hole, and the first connector is electrically connected to the first body assembly after passing through the second through hole.

In an embodiment, the battery compartment and the second recess are separated by a second partition, the charging electrode includes a fourth power terminal and a second connector, the barrel structure has a third through hole and a fourth through hole penetrating the battery compartment and the charging compartment, the fourth power terminal is electrically connected to the second body assembly after passing through the third through hole, and the second connector is electrically connected to the second body assembly after passing through the fourth through hole.

In an embodiment, a sidewall of the first recess and a sidewall of the second recess are each provided with a magnetic member.

In an embodiment, the first body assembly includes a first main board and a backup battery electrically connected to each other, and the charging electrode and the second body assembly are each connected to the first main board.

In an embodiment, the first body assembly includes a recording and translation module, and the rechargeable battery is further configured to provide electrical energy to the recording and translation module.

The present disclosure provides a touch device, which includes a wireless earphone and the above-described stylus. The wireless earphone is detachably accommodated in the charging compartment and electrically connected to the charging electrode of the stylus.

In an embodiment, the touch device includes two wireless earphones, the first body assembly of the stylus is configured to charge one of the two wireless earphones, and the first body assembly is further configured to charge the other of the two wireless earphones through the second body assembly of the stylus.

The present disclosure has at least the beneficial effects below.

In the stylus provided by the present disclosure, a charging compartment and a charging electrode are provided so that the stylus not only has the function of touch control, but also has the function of accommodating a wireless electronic device, thereby enriching the functions of the stylus, improving the utilization rate of the stylus, and thus increasing the utilization value of the stylus.

The touch device provided by present disclosure can accommodate a wireless earphone and charge the wireless earphone, thereby reducing the risk of losing the wireless earphone, facilitating the charging of the wireless earphone and increasing the utilization value of the touch device.

### BRIEF DESCRIPTION OF DRAWINGS

FIG. 1 is a structure view of a stylus according to an embodiment of the present disclosure.

FIG. 2 is an exploded view of the stylus according to the embodiment of the present disclosure.

FIG. 3 is a side view of the stylus according to the embodiment of the present disclosure.

FIG. 4 is a cross-sectional view taken along a line A-A shown in FIG. 3 according to the embodiment of the present disclosure.

FIG. 5 is an enlarged view at a position G shown in FIG. 4 according to the embodiment of the present disclosure.

FIG. 6 is a front view of the stylus according to the embodiment of the present disclosure.

FIG. 7 is a cross-sectional view taken along a line B-B shown in FIG. 5 according to the embodiment of the present disclosure.

FIG. 8 is an exploded view of the stylus according to the embodiment of the present disclosure.

FIG. 9 is an enlarged view at a position C shown in FIG. 7 according to the embodiment of the present disclosure.

FIG. 10 is an enlarged view at a position D shown in FIG. 7 according to the embodiment of the present disclosure.

FIG. 11 is an assembly view of a first power terminal, a second power terminal and a charging electrode according to the embodiment of the present disclosure.

FIG. 12 is a structure view of a first sleeve according to the embodiment of the present disclosure.

FIG. 13 is a structure view of a second sleeve according to the embodiment of the present disclosure.

In the figures: 1—barrel structure; 11—first sleeve; 111—first recess; 112—raised structure; 12—second sleeve; 121—second recess; 122—outer sleeve; 123—connection portion; 13—first partition; 14—second partition; 15—first through hole; 16—second through hole; 17—third through hole; 18—fourth through hole; 21—functional compartment; 22—charging compartment; 23—battery compartment; 3—charging electrode; 31—third power terminal; 32—first connector; 33—fourth power terminal; 34—second connector; 4—first body assembly; 41—first main board; 42—backup battery; 5—second body assembly; 51—second main board; 52—rechargeable battery; 53—charging interface; 61—first power terminal; 611—spring; 62—second power terminal; 621—ring; 7—magnetic member; 8—stylus tip; 91—switch button; 92—function button; 10—stylus; and 20—wireless earphone

### DETAILED DESCRIPTION

To make the solved technical problems, the adopted technical solutions and the achieved technical effects in the present disclosure clearer, the technical solutions of the present disclosure will be further described below with reference to the drawings and embodiment. It should be understood that the embodiment described here are only used for explaining the present disclosure, rather than limiting the present disclosure. In addition, it should be noted that, to facilitate description, the drawings show only part, not all, related to the present disclosure.

In the description of the present disclosure, it should be noted that orientations or position relations indicated by terms “center”, “upper”, “lower”, “left”, “right”, “vertical”, “horizontal”, “in”, “out” and the like are orientations or position relations based on the drawings. These orientations or position relations are only for the convenience of describing the present disclosure and simplifying the description, and do not indicate or imply that a device or element referred to must have such specific orientations, or be configured or operated in such specific orientations. Thus, these orientations or position relations shall not be construed as limiting the present disclosure. In addition, terms “first”, “second” and the like are used for the purpose of description, and shall not be construed as indicating or implying relative importance.

In the description of the present disclosure, it should also be noted that terms “mounted”, “joined” and “connected” shall be understood in a broad sense unless otherwise expressly specified and limited. For example, the term “connected” may refer to “fixedly connected” or “detachably connected”. In addition, the term “connected” may refer to “mechanically connected” or “electrically connected”. Further, the term “connected” may refer to “connected directly”, “connected indirectly through an intermediary” or “communicated in two components”. For those of ordinary skill in the art, specific meanings of the above terms in the present disclosure may be understood according to specific situations.

This embodiment provides a stylus 10, which can be used not only for touch control, but also for accommodating and charging a wireless electronic device. Thus, the stylus has a high utilization rate. The electronic device may be a lightweight and small wireless electronic product, such as a wireless earphone 20.

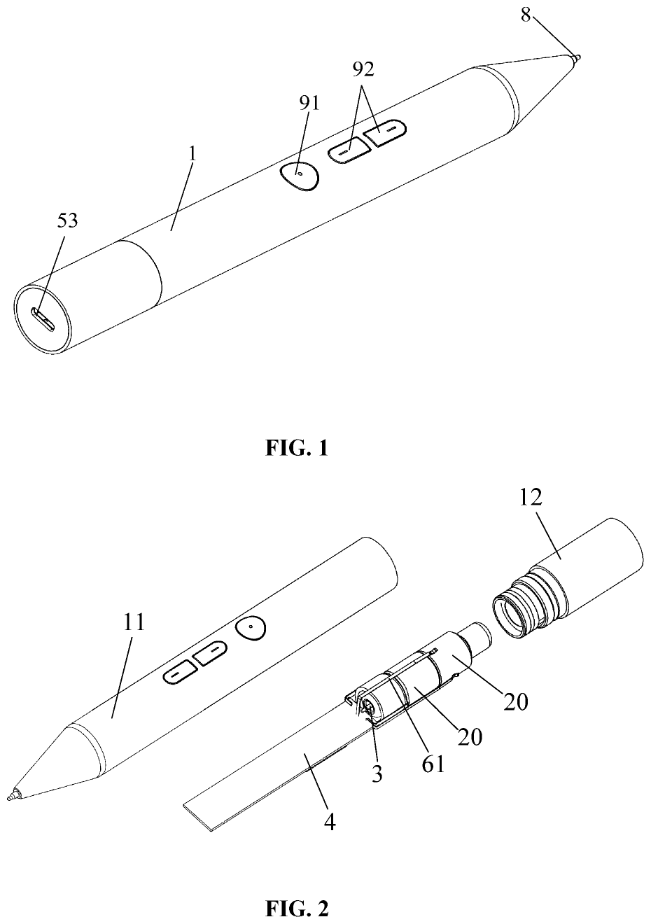

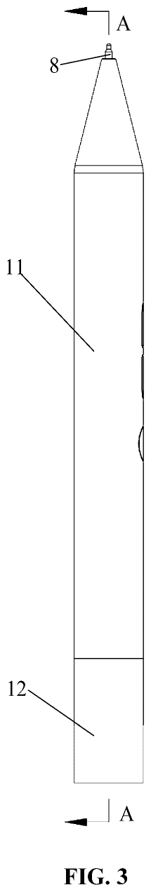

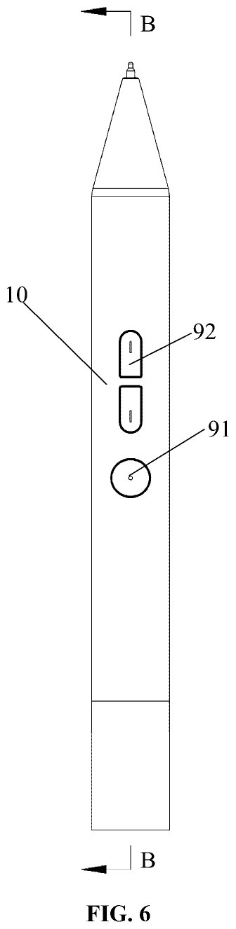

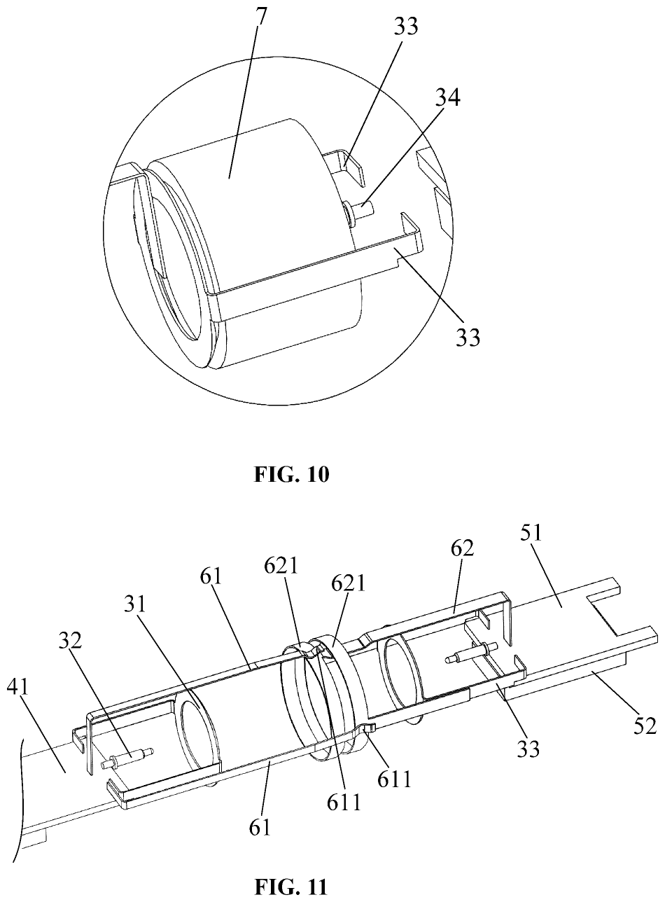

As shown in FIGS. 1 to 13, the stylus 10 includes a barrel structure 1, a charging electrode 3 located in the barrel structure 1, a first body assembly 4, a second body assembly 5 and a stylus tip 8 located at one end of the barrel structure 1. The stylus tip 8 can be fixed to the one end of the barrel structure 1 and used to touch a wireless electronic product with a touch function, so that the stylus 10 in this embodiment has the function of touch control. In one embodiment, the stylus tip 8 is also electrically connected to the first body assembly 4.

A functional compartment 21, a charging compartment 22 and a battery compartment 23 are sequentially disposed in the barrel structure 1. The above-described charging electrode 3 is disposed in the charging compartment 22, and can charge a wireless electronic device (such as a wireless earphone 20) located in the charging compartment 22. The first body assembly 4 is located in the functional compartment 21 and electrically connected to the charging electrode 3. The first body assembly 4 is used to provide electrical energy to the charging electrode 3 so that the charging electrode 3 can charge the wireless electronic device. In one embodiment, the first body assembly 4 can also be used to achieve recording and translation functions. For example, the first body assembly 4 can include a recording and translation module. The recording and translation module is a hardware and software module for achieving recording and translation functions. The hardware can be disposed on a main board and/or integrated in a chip. The software can be recorded in a memory on the main board and executed by the chip. The recording and translation module may include a microphone for recording, a memory for storing audio files, codes for translating, and a database for storing the codes. The recording and translation module is electrically connected to the second body assembly 5, and the second body assembly 5 can supply electrical energy to the recording and translation module. In other embodiments, the hardware and software constituting the recording and translation module may be achieved with reference to conventional techniques.

The second body assembly 5 is located in the battery compartment 23, and the second body assembly 5 is electrically connected to the charging electrode 3 and the first body assembly 4 respectively. The second body assembly 5 includes a rechargeable battery 52. The rechargeable battery 52 can provide electrical energy to the charging electrode 3, and can also provide electrical energy to the first body assembly 4. That is, the rechargeable battery 52 of the second body assembly 5 can directly provide electrical energy to the charging electrode 3, and can also provide electrical energy to the charging electrode 3 through the first body assembly 4. In one embodiment, the rechargeable battery 52 is also used to provide electrical energy to the recording and translation module.

According to the stylus 10 provided in this embodiment, the charging compartment 22 and the charging electrode 3 are provided so that the stylus 10 not only has the function of touch control, but also has the function of accommodating a wireless electronic device, thereby enriching the functions of the stylus 10, improving the utilization rate of the stylus 10, and thus increasing the utilization value of the stylus 10.

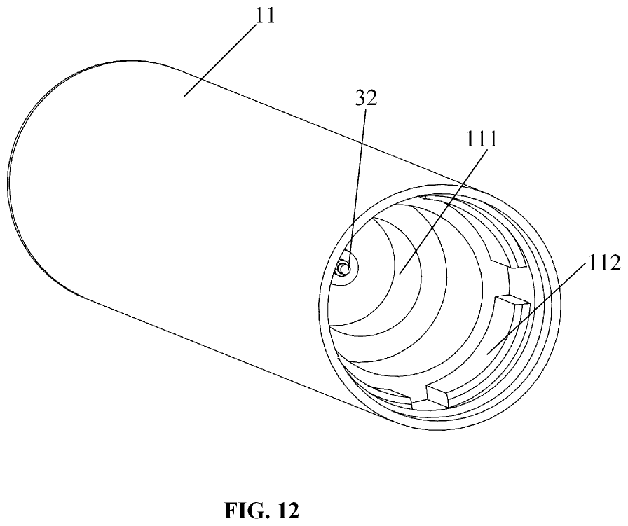

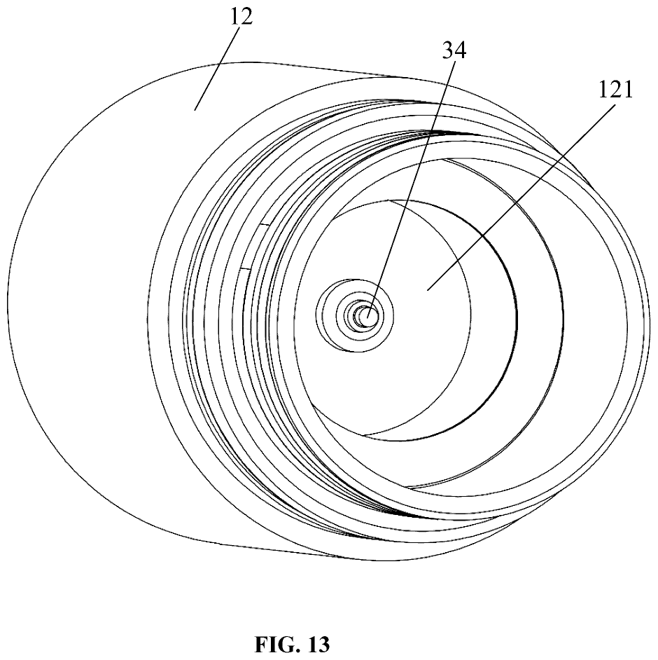

In this embodiment, as shown in FIG. 2, the barrel structure 1 may include a first sleeve 11 and a second sleeve 12 that are detachably connected. The stylus tip 8 is connected to one end of the first sleeve 11, the functional compartment 21 is located in the first sleeve 11, and the battery compartment 23 is located in the second sleeve 12. As shown in FIG. 12, one end of the first sleeve 11 has a first recess 111 recessed inwards, and a depth direction of the first recess 111 is parallel to a length direction of the first sleeve 11. As shown in FIG. 13, one end (i.e., an end connected to the first sleeve 11) of the second sleeve 12 has a second sleeve 121 recessed inwards, and a depth direction of the second sleeve 121 is parallel to a length direction of the second sleeve 12. When the first sleeve 11 is connected to the second sleeve 12, the first recess 111 and the second recess 121 can be engaged with each other to form the charging chamber 22 described above.

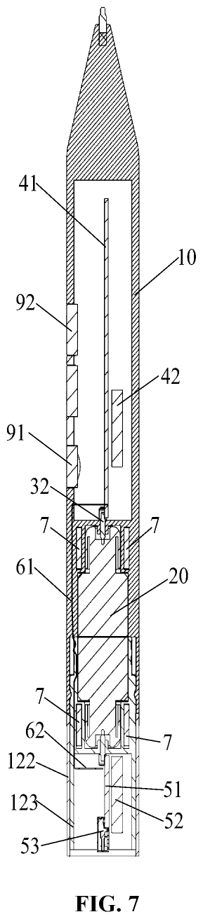

In an embodiment, a connection manner of the first sleeve 11 and the second sleeve 12 may be threaded connection, locking connection or magnetic connection, and the connection manner is not limited in this embodiment. In one connection manner of the first sleeve 11 and the second sleeve 12, as shown in FIG. 7, the second sleeve 12 may include a connection portion 123 and an outer sleeve 122 that is sleeved on a part of the connection portion 123. A part of the connection portion 123 that is not wrapped by the outer sleeve 122 is located in the first sleeve 11 and engaged with the first sleeve 11 in a locking connection manner. As shown in FIG. 12, the first sleeve 11 may have one or more convex structures 112 for locking the connection portion 123.

In an embodiment, as shown in FIG. 1, one or more buttons, such as a switch button 91 and a function button 92, may be disposed on the first sleeve 11.

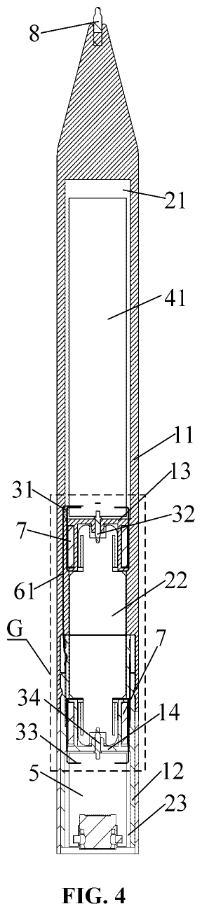

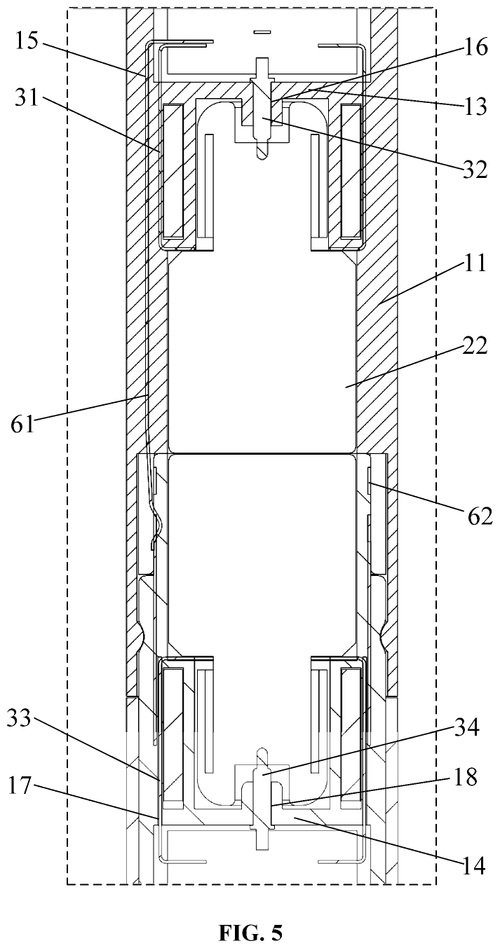

In this embodiment, as shown in FIG. 4, FIG. 5 or FIG. 7, the second body assembly 5 may be electrically connected to the first body assembly 4 through a first power terminal 61 and a second power terminal 62. Specifically, the first power terminal 61 is fixed to the first sleeve 11, one end of the first power terminal 61 can be electrically connected to the second power terminal 62, and the other end of the first power terminal 61 is electrically connected to the first body assembly 4. The second power terminal 62 is fixed to the second sleeve 12, one end of the second power terminal 62 can be electrically connected to the first power terminal 61, and the other end of the second power terminal 62 is electrically connected to the second body assembly 5. When the first sleeve 11 is connected to the second sleeve 12, the first power terminal 61 can make contact with and be electrically connected to the second power terminal 62.

In an embodiment, as shown in FIG. 11, the stylus 10 may include two first power terminals 61 and two second power terminals 62. One end of each of the two first power terminals 61 is a spring 611, and one end of each of the two second power terminals 62 is a ring 621 fixed to the second sleeve 12. When the first sleeve 11 is connected to the second sleeve 12, the two springs 611 of the two first power terminals 61 can respectively make elastic contact with and be electrically connected to the two rings 621 of the two second power terminals 62 on a one-to-one basis. The two rings 621 are annular and sleeved on the second sleeve 12, so that once the first sleeve 11 is engaged with the second sleeve 12, the two springs 611 of the two first power terminals 61 can make contact with the two rings 621 on a one-to-one basis without the need to rotate and adjust the second sleeve 12. Such configuration facilitates the electrical connection of the first power terminals 61 to the second power terminals 62.

Further, with reference to FIGS. 4 and 5, the functional compartment 21 and the first recess 111 may be separated by a first partition 13. That is, the bottom of the first recess 111 is the first partition 13 so that the functional compartment 21 and the charging compartment 22 may be independent of each other to avoid mutual interference. Similarly, the battery compartment 23 and the charging compartment 22 may be separated by a second partition 14. That is, the bottom of the second recess 121 is the second partition 14 so that the battery compartment 23 and the charging compartment 22 can be independent of each other to avoid mutual interference.

In an embodiment, with reference to FIG. 4 and FIG. 5, the first partition 13 and the first sleeve 11 may be an integral structure. That is, the first partition 13 and the first sleeve 11 may be manufactured in the same manufacturing process, which improves the connection strength between the first partition 13 and the first sleeve 11 and also facilitates the manufacture of the stylus 10. Similarly, the second partition 14 and the second sleeve 12 may be an integrated structure to improve the connection strength of the second partition 14 and the second sleeve 12.

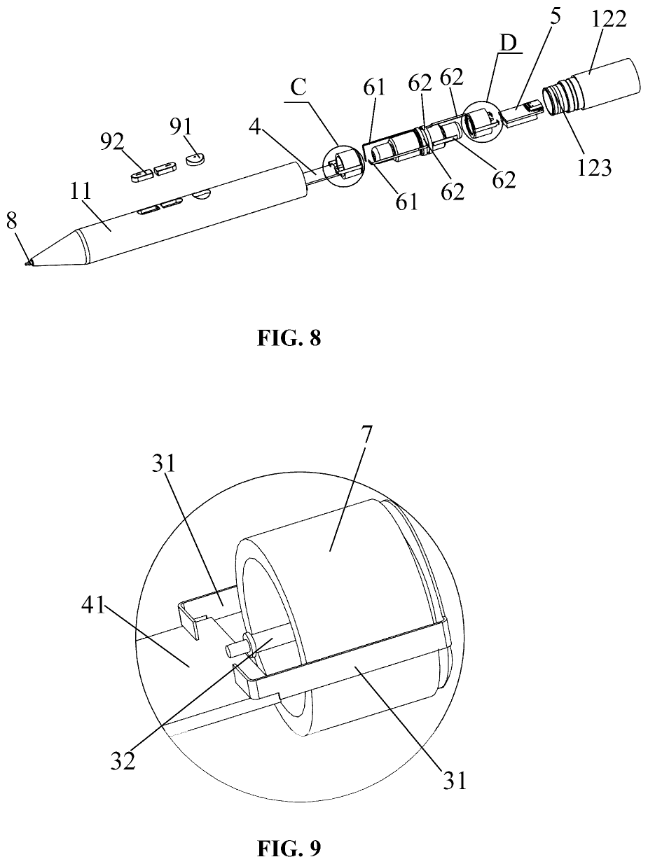

Further, with reference to FIG. 4, FIG. 8 or FIG. 9, the charging electrode 3 may include a third power terminal 31 and a first connector 32. In addition, the first sleeve 11 of the barrel structure 1 has a first through hole 15 and a second through hole 16 penetrating the functional compartment 21 and the charging compartment 22, as shown in FIG. 5. One end of the third power terminal 31 can enter the charging compartment 22 and is located in the charging compartment 22. The other end of the third power terminal 31 is electrically connected to the first body assembly 4 after passing through the first through hole 15. One end of the first connector 32 can enter the charging compartment 22 and is located in the charging compartment 22. The other end of the first connector 32 is electrically connected to the first body assembly 4 after passing through the second through hole 16. In an embodiment, one of the third power terminal 31 and the first connector 32 is connected to a positive pole in the first body assembly 4, and the other of the third power terminal 31 and the first connector 32 is connected to a negative pole in the first body assembly 4. Further, as shown in FIG. 5, the second through hole 16 may be located on the first partition 13.

Further, with reference to FIGS. 4, 8 and 10, the charging electrode 3 further includes a fourth power terminal 33 and a second connector 34. The second sleeve 12 of the barrel structure 1 has a third through hole 17 and a fourth through hole 18 penetrating the battery compartment 23 and the charging compartment 22, as shown in FIG. 5. One end of the fourth power terminal 33 can enter the charging compartment 22 and is located in the charging compartment 22. The other end of the fourth power terminal 33 is electrically connected to the second body assembly 5 after passing through the third through hole 17. One end of the second connector 34 can enter the charging compartment 22 and is located in the charging compartment 22. The other end of the second connector 34 is electrically connected to the second body assembly 5 after passing through the fourth through hole 18. In an embodiment, one of the fourth power terminal 33 and the second connector 34 is connected to a positive pole of the second body assembly 5, and the other of the fourth power terminal 33 and the second connector 34 is connected to a negative pole of the second body assembly 5. Further, as shown in FIG. 5, the fourth through hole 18 may be located on the second partition 14.

In an embodiment, as shown in FIG. 7, a recess wall of the first recess 111 and a recess wall of the second recess 121 are each provided with a magnetic member 7 for attracting and fixing a wireless electronic device (such as a wireless earphone 20) located in the charging compartment 22, so that the charging electrode 3 can stably charge the wireless electronic devices, thereby improving the charging efficiency.

Further, as shown in FIGS. 12 and 13, both the first recess 111 and the second recess 121 may be stepped recesses. In this case, the first recess 111 includes a lower part of a smaller size and an upper part of a larger size. The lower part of the first recess 111 has a thicker sidewall, and a magnetic member 7 is located on the sidewall of the lower part of the first recess 111. Specifically, the magnetic member 7 may be embedded in the sidewall of the lower part of the first recess 111. Similarly, the second recess 121 includes a lower part with a smaller size and an upper part with a larger size. The lower part of the second recess 121 has a thicker sidewall, and another magnetic member 7 is located on the sidewall of the lower part of the second recess 121. Specifically, the another magnetic member 7 may be embedded in the sidewall of the lower part of the second recess 121.

In an embodiment, with reference to FIG. 8, each magnetic member 7 may have a hollow cylindrical shape, and the third power terminal 31 and the fourth power terminal 33 may be each sleeved on the two magnetic members 7.

In this embodiment, as shown in FIG. 7, the first body assembly 4 includes a first main board 41 and a backup battery 42 that are electrically connected to each other. The charging electrode 3 and the second body assembly 5 are each electrically connected to the first main board 41. That is, the first power terminal(s) 61, the third power terminal 31 and the first connector 32 are all electrically connected to the first main board 41. In addition, the second body assembly 5 can also be used to charge the backup battery 42 through the first main board 41, and the backup battery 42 can provide electrical energy to the charging electrode 3 through the first main board 41. That is, the backup battery 42 can also charge the wireless electronic device(s) in the charging compartment 22, thereby further enriching the functions of the stylus 10.

In an embodiment, as shown in FIG. 7, the second body assembly 5 further includes a second main board 51 electrically connected to the rechargeable battery 52, and a charging interface 53 electrically connected to the second main board 51. The first main board 41 and the charging electrode 3 are each electrically connected to the second main board 51. That is, the second connector 34, the fourth power terminal 33 and the second power terminal(s) 62 are all electrically connected to the second main board 51. The charging interface 53 is located at the end of the second main board 51, and a data cable hole through which the charging interface 53 passes is disposed at the end of the second sleeve 12.

This embodiment also provides a touch device, which includes the above-described stylus 10 and a wireless earphone 20. The wireless earphone 20 is detachably accommodated in the charging compartment 22 of the stylus 10, and the charging electrode 3 in the charging compartment 22 can charge the wireless earphone 20. That is, the wireless earphone 20 can be electrically connected to the charging electrode 3.

Further, as shown in FIG. 7, the touch device may include two wireless earphones 20. The two wireless earphones 20 can be magnetically connected, and are both located in the charging compartment 22. The first body assembly 4 in the stylus 10 can charge one of the two wireless headphones 20 through the third power terminal 31 and the first connector 32. The first body assembly 4 can also charge the other of the two wireless headphones 20 through the second body assembly 5. Specifically, the second body assembly 5 charges the other of the two wireless headphones 20 through the fourth power terminal 33 and the second connector 34. For example, the two wireless headphones 20 may be accommodated in the first recess 111 and the second recess 121, respectively, and be electrically connected to the first body assembly 4 and the second body assembly 5 through the third power terminal 31 and the first connector 32 in the first recess 111 and the fourth power terminal 33 and the second connector 34 in the second recess 121, respectively.

In an embodiment, in this embodiment, a force of attraction between the two Bluetooth earphones 20 is greater than a force of attraction of the two Bluetooth earphones 20 to the charging compartment 11 so that the two Bluetooth earphones 20 can be easily taken and placed.

In an embodiment, the Bluetooth earphone 20 in this embodiment can be a Bluetooth wireless earphone with true wireless stereo (TWS), which can be paired with the stylus itself, and can also be paired with other Bluetooth-enabled devices such as a mobile phone and a vehicle-mounted Bluetooth device.

The above embodiment illustrates only the basic principle and characteristics of the present disclosure. The present disclosure is not limited by the above embodiment. Various modifications and variations made without departing from the spirit and scope of the present disclosure shall fall within the scope of the present disclosure. The scope of the present disclosure is defined by the appended claims and their equivalents.

What is claimed is:

1. A stylus, comprising:
a barrel structure comprising a functional compartment, a charging compartment and a battery compartment sequentially arranged in the barrel structure, the charging compartment being provided with a charging electrode disposed therein;
a first body assembly located in the functional compartment and electrically connected to the charging electrode;
a second body assembly located in the battery compartment, wherein the second body assembly is electrically connected to the charging electrode and the first body assembly respectively, the second body assembly comprises a rechargeable battery, and the rechargeable battery is configured to provide electrical energy to the charging electrode through the first body assembly and the second body assembly so as to enable the charging electrode to charge a wireless earphone accommodated in the charging compartment; and
a stylus tip located at one end of the barrel structure.

2. The stylus of claim 1, wherein the barrel structure comprises a first sleeve and a second sleeve that are detachably connected, the functional compartment is located in the first sleeve, the battery compartment is located in the second sleeve, one end of the first sleeve has a first recess, one end of the second sleeve has a second recess, and the first recess and the second recess are capable of engaging with each other to form the charging compartment.

3. The stylus of claim 2, wherein the second body assembly is electrically connected to the first body assembly through a first power terminal and a second power terminal, the first power terminal is fixed to the first sleeve and electrically connected to the first body assembly, the second power terminal is fixed to the second sleeve and electrically connected to the second body assembly, and when the first sleeve is connected to the second sleeve, the first power terminal is enabled to be in contact with and electrically connected to the second power terminal.

4. The stylus of claim 3, further comprising two first power terminals and two second power terminals, wherein one end of each of the two first power terminals is a spring, one end of each of the two second power terminals is a ring fixed to the second sleeve, and when the first sleeve is connected to the second sleeve, the spring of the each of the two first power terminals is enabled to be in contact with and electrically connected to the corresponding ring of the each of the two second power terminals.

5. The stylus of claim 2, wherein the functional compartment and the first recess are separated by a first partition, the charging electrode comprises a third power terminal and a first connector, the barrel structure has a first through hole and a second through hole penetrating the functional compartment and the charging compartment, the third power terminal is electrically connected to the first body assembly after passing through the first through hole, and the first connector is electrically connected to the first body assembly after passing through the second through hole.

6. The stylus of claim 2, wherein the battery compartment and the second recess are separated by a second partition, the charging electrode comprises a fourth power terminal and a second connector, the barrel structure has a third through hole and a fourth through hole penetrating the battery compartment and the charging compartment, the fourth power terminal is electrically connected to the second body assembly after passing through the third through hole, and the second connector is electrically connected to the second body assembly after passing through the fourth through hole.

7. The stylus of claim 2, wherein a sidewall of the first recess and a sidewall of the second recess are each provided with a magnetic member.

8. The stylus of claim 1, wherein the first body assembly comprises a first main board and a backup battery electrically connected to each other, and the charging electrode and the second body assembly are each connected to the first main board.

9. The stylus of claim 1, wherein the first body assembly includes a recording and translation module, and the rechargeable battery is further configured to provide electrical energy to the recording and translation module.

10. A touch device, comprising a wireless earphone and the stylus of claim 1, the wireless earphone being detachably accommodated in the charging compartment and electrically connected to the charging electrode of the stylus.

11. The touch device of claim 10, wherein the touch device comprises two wireless earphones, the first body assembly of the stylus is configured to charge one of the two wireless earphones, and the first body assembly is further configured to charge the other of the two wireless earphones through the second body assembly of the stylus.

12. The touch device of claim 10, wherein the barrel structure comprises a first sleeve and a second sleeve that are detachably connected, the functional compartment is located in the first sleeve, the battery compartment is located in the second sleeve, one end of the first sleeve has a first recess, one end of the second sleeve has a second recess, and the first recess and the second recess are capable of engaging with each other to form the charging compartment.

13. The touch device of claim 12, wherein the second body assembly is electrically connected to the first body assembly through a first power terminal and a second power terminal, the first power terminal is fixed to the first sleeve and electrically connected to the first body assembly, the second power terminal is fixed to the second sleeve and electrically connected to the second body assembly, and when the first sleeve is connected to the second sleeve, the first power terminal is enabled to be in contact with and electrically connected to the second power terminal.

14. The touch device of claim 13, wherein the stylus further comprises two first power terminals and two second power terminals, one end of each of the two first power terminals is a spring, one end of each of the two second power terminals is a ring fixed to the second sleeve, and when the first sleeve is connected to the second sleeve, the spring of the each of the two first power terminals is enabled to be in contact with and electrically connected to the corresponding ring of the each of the two second power terminals.

15. The touch device of claim 12, wherein the functional compartment and the first recess are separated by a first partition, the charging electrode comprises a third power terminal and a first connector, the barrel structure has a first through hole and a second through hole penetrating the functional compartment and the charging compartment, the third power terminal is electrically connected to the first body assembly after passing through the first through hole, and the first connector is electrically connected to the first body assembly after passing through the second through hole.

16. The touch device of claim 12, wherein the battery compartment and the second recess are separated by a second partition, the charging electrode comprises a fourth power terminal and a second connector, the barrel structure has a third through hole and a fourth through hole penetrating the battery compartment and the charging compartment, the fourth power terminal is electrically connected to the second body assembly after passing through the third through hole, and the second connector is electrically connected to the second body assembly after passing through the fourth through hole.

17. The touch device of claim 12, wherein a sidewall of the first recess and a sidewall of the second recess are each provided with a magnetic member.

18. The touch device of claim 10, wherein the first body assembly comprises a first main board and a backup battery electrically connected to each other, and the charging electrode and the second body assembly are each connected to the first main board.

19. The touch device of claim 10, wherein the first body assembly includes a recording and translation module, and the rechargeable battery is further configured to provide electrical energy to the recording and translation module.
